(19) United States
(12) Patent Application Publication
(10) Pub. No.: US 2014/0311012 A1
(43) Pub. Date: Oct. 23, 2014

(54) Releasable Sinkers for Marine Applications

(71) Applicant: Robert Paul Bono, Dana Point, CA (US)

(72) Inventor: Robert Paul Bono, Dana Point, CA (US)

(21) Appl. No.: 14/256,900

(22) Filed: Apr. 18, 2014

Related U.S. Application Data
(60) Provisional application No. 61/813,404, filed on Apr. 18, 2013.

(51) Int. Cl. A01K 95/02

(52) U.S. Cl. CPC A01K 95/02
USPC 43/43.12

(57) ABSTRACT

Releasable sinkers for marine applications are described, each of which utilizes rapidly disintegrating water soluble material as an attachment means or as part of an attachment assembly for securing a weight to fishing line. Depending on the configuration of the rapidly disintegrating water soluble material, after exposing the sinker to water, for example, by casting a line into the water or by returning a caught fish back into the water, the rapidly disintegrating water soluble material will dissolve, thereby releasing the sinker from the fishing line. The weighted portion of the sinker, which provides the majority of sinker weight, may be preferably formed from an organic material that will also eventually dissolve in water, although at a much slower rate than the rapidly disintegrating water soluble material.

### RELATED APPLICATIONS

This application claims priority to U.S. Provisional Application 61/813,404 filed on Apr. 18, 2013, which is fully incorporated herein by reference.

### BACKGROUND OF THE INVENTION

1. Field of the Invention

The present invention relates generally to sinkers for marine applications, particularly to sinkers that automatically release from fishing line by action of water soluble material.

2. Description of Related Art

Related art is described in U.S. patent application Ser. No. 14/156,109 of applicant Robert Paul Bono, which application is fully incorporated herein by reference.

### SUMMARY OF THE INVENTION

The present invention provides advancements in the art of releasable sinker design for marine applications. Three related embodiments are described, each of which utilizes rapidly disintegrating water soluble material as an attachment means or as part of an attachment assembly for securing a weight to fishing line. Depending on the configuration of the rapidly disintegrating water soluble material, after exposing the sinker to water, for example, by casting a line into the water or by returning a fish back into the water, the rapidly disintegrating water soluble material will dissolve, thereby releasing the sinker from the fishing line. The weighted portion of the sinker, which provides the majority of sinker weight, may be preferably formed from an organic material that will also eventually dissolve in water, although at a much slower rate than the rapidly disintegrating water soluble material.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. Dimensions shown are exemplary only. In the drawings, like reference numerals may designate like parts throughout the different views, wherein:

FIG. 1 is an isometric view of a puck-type design for a releasable sinker according to a first embodiment of the invention.

FIG. 2 is a perspective view of the puck-type sinker of FIG. 1.

FIG. 3 is a sketch of a sinker assembly showing a piggy-back design for a releasable sinker according to a second embodiment of the invention.

FIG. 4 is a series of diagrams showing, in three different states of use, a catch-and-release design for a releasable sinker according to a third embodiment of the invention.

### DETAILED DESCRIPTION OF THE INVENTION

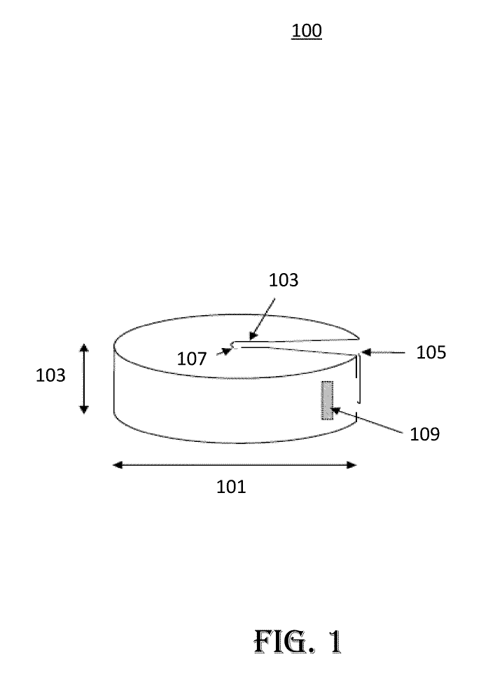

FIG. 1 shows a puck-type design for a releasable sinker. This design is generally cylindrical, having a base 101 of a greater dimension that its height 103. In one embodiment, the base 101 may be about 1 ¾ inches in diameter and the height 103 may be about 1 inch. An opening 105 is cut from the side of the sinker to its center, and runs completely through the height of the sinker, as shown. The opening 105 is preferably wider at the perimeter of the sinker than at the center, to facilitate threading fishing line at the center. The opening 105 may be generally wedge-shaped, as shown. In one embodiment, the opening 105 at the perimeter may be about ¼ inch, and may extend toward the center of the sinker, where it may straighten to form a generally rectangular slit 107 about ¼ inch long and about 1/16 inch wide to accommodate fishing line with plenty of margin. A slot 109 is cut through the side of the sinker to an interior side of the opening 105, as shown. The slot 109 is sized to accommodate a rapidly disintegrating water soluble strip (not shown). In one embodiment, the slot 109 may be generally rectangular having dimensions of about ⅛ inch wide by ⅝ inch high, It may be located, at the perimeter of the sinker, about ¼ inch from the opening 105.

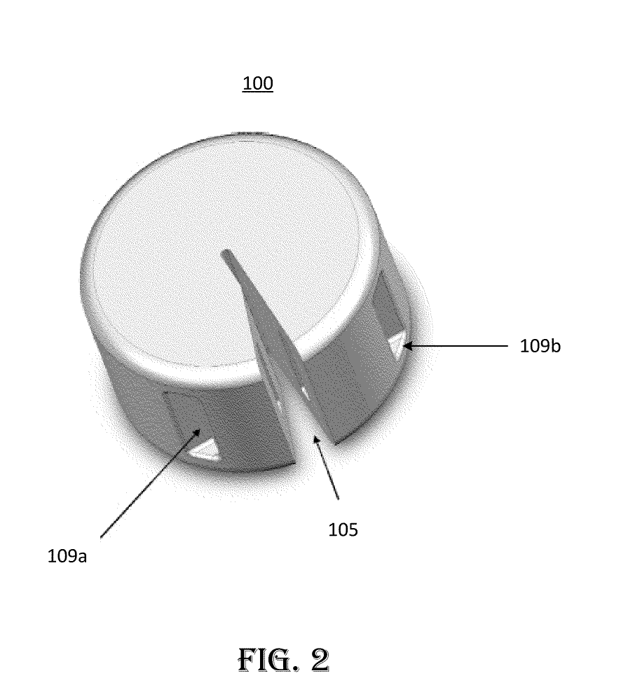

FIG. 2 shows a perspective view of the puck type sinker 100. In this embodiment, the opening 105 is an asymmetrical wedge, with one straight edge and one angled edge; however, in other embodiments the opening 105 may have a symmetrical shape, such as one that comprises a wedge having identically angled sides. This figure shows slot 109 as two slots 109a and 109b cut on either side of the opening 105. Slots 109a and 109b are preferably dimensionally similar, casting mirror images of one another.

In one embodiment, the weight of the sinker 100 is about 1.75 ounces given a density of sinker material of about 1.3 with respect to the density of water. The sinker 100 may be formed from metal, clay, stone, cement, mortar, or other material having a greater density than water. In another embodiment, the sinker may be formed from a ceramic material having a density of up to about twice that of water. Sizes of sinker 100 may vary to achieve weight from about 1.75 ounces to about 3.5 ounces for the typical dimensions disclosed herein.

In operation, fishing line is fed into the opening 105 to the center slit 107. A rapidly disintegrating water soluble material is then pushed through slot 109 from one side to the other (that is, through both 109a and 109b), to link the fishing line to the sinker. The wall of the rapidly disintegrating water soluble material acts as a gate that will not allow the sinker to detach from the fishing line until some time after the sinker enters the water. When the sinker has been immersed in the water for a period of time sufficient to cause the rapidly disintegrating water soluble material to dissolve, the fishing line is free to emerge from the opening 105, or equivalently, the sinker 100 detaches and drifts away from the fishing line. The rapidly disintegrating water soluble material may be, for example, a strip of dissolvable paper that is folded a number of times to achieve optimal or desired dimensions and/or dissolving time.

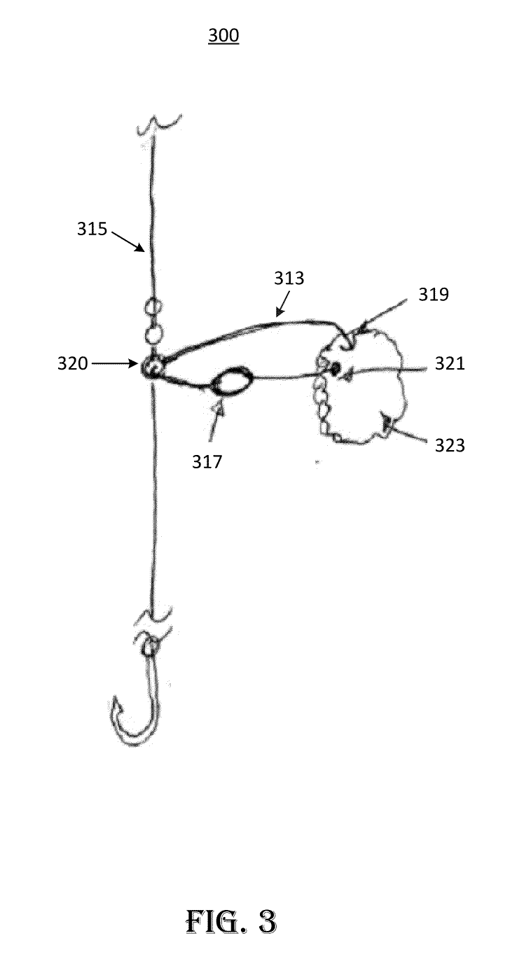

FIG. 3 shows an embodiment according to the invention of a releasable sinker assembly known herein as the piggy-back design. In this embodiment, a loop 313 of fishing line is attached to a fixed point 320 on a main fishing line 315. The loop 313 may have either loose ends or reattachable ends that allow one of its ends to be threaded through the fixed point 320 and then both ends attached to a weighted bag 323 at points 319 and 321. For example, the fishing line loop 313 may pass through the bag 323 at 319 and 321, or it may be tied or otherwise attached at these locations.

The fixed point 320 may be, for example, a swivel with at least one eyelet, or a split shot or rubber-core sinker. The weighted bag 323 may contain a low-cost weight such as salt, rocks, gravel, sand, etc.. This weight may typically be about 1 to 3 ounces, though other weights are certainly possible within the scope of the invention. The bag itself may be formed from material such as cloth, paper, or a biodegradable or disintegrating material.

A dissolvable paper loop 317 forms a link within the fishing line loop 313, as shown. The dissolvable paper loop 317 is formed from a rapidly disintegrating water soluble material. When the entire fishing sinker assembly 300 enters the water after casting, the dissolvable paper loop 317 dissolves and opens to release the weighted bag 323 from the main fishing line 315.

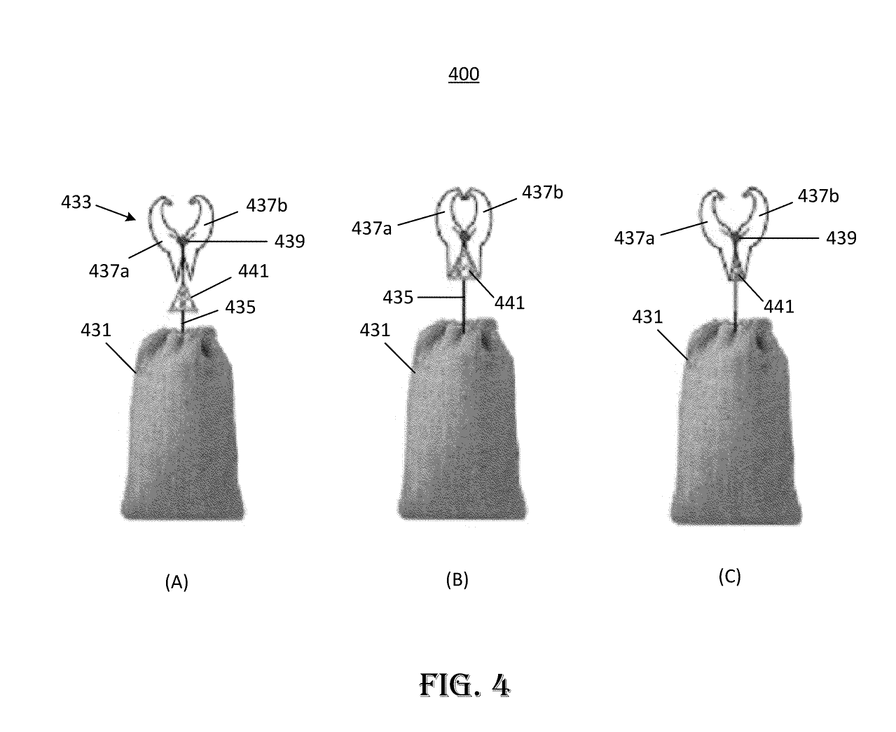

FIG. 4 shows a series of diagrams, representing three different states of use (A, B, C) of a sinker assembly 400. Sinker 400 is known herein as the catch-and-release design for a releasable sinker according to an embodiment of the invention. This design enables a caught fish under barometric stress to be harmlessly returned to the body of water from which it was caught. Using this device, the fish may be placed into the water and taken down to an appropriate depth where it can repressurize and recover.

The sinker 400 includes a bag 431 filled with weight and a clamping mechanism 433 that is attached to the top of the bag 431 by a line 435. The clamping mechanism includes two jaws 437a and 437b and a coil spring 439. A wedge 441 formed from rapidly disintegrating water soluble material is threaded onto the line 435.

With the sinker 400 resting in its shelf or non-operating state shown in diagram A, the coil spring 439 in the clamping mechanism 433 maintains the jaws 437a and 437b in an open position, as shown. In operation, for example, when clamping the sinker 400 to a fish's mouth or gills, the jaws 437a and 437b are manually closed against the force of coil spring 439 and maintained closed by positioning the wedge 441 between the jaws, as shown in diagram B. The wedge 441 may simply be pushed up along the line 435 until it locks into position between the jaws to wedge them open. This action effectively attaches the caught fish to the bag 431.

In further operation, the fish along with the sinker 400 may be released in to the water, so that the weight drags the fish down to a lower depth. As soon as the assembly enters the water, the wedge 441 begins to dissolve, and eventually weakens to the point where the coil spring 439 forces open the jaws of the clamping mechanism 433, thereby releasing the fish. This state is shown in diagram C. There, what remains of wedge 441 is compressed between the jaws 437a and 437b under force of the coil spring 439.

By selecting the plastic type, or by controlling the surface area and volume of the wedge 441, the wedge can be made to dissolve at differing rates or to release the clamp at differing depths. Stated differently, various controls on the materials and configuration of the wedge 441 enable the designer to control the amount of time required for the wedge 441 to dissolve to the point where the coil spring forces open the clamping mechanism. Once open, the fish is free to swim away, and has a better chance of survival because it was able to recover at a proper depth and was thus not barometrically stressed by being released at the surface.

In another embodiment, the clamping mechanism may be replaced with a simple loop of fishing line, wherein a portion of the loop comprises a length of rapidly disintegrating water soluble material. The line that forms the loop may first be threaded through the fish's gills and then joined in a loop, or it may be a lasso that is tightened behind the fish's head. The loop is configured so that when immersed, the dissolvable portion breaks apart and opens the loop to free the fish.

In any of the foregoing embodiments, the rapidly disintegrating water soluble material may comprise a polyvinyl alcohol plastic, a polyglycolic acid plastic, or a dissolving paper product.

What is claimed is:

1. The releasably sinker of the puck type design as shown in FIGS. 1 and 2 and described herein.

2. The releasable sinker of the piggy-back design as shown in FIG. 3 and as described herein.

3. The releasable sinker of the catch-and-release design as shown in FIG. 4 and as described herein.
